(19) United States
(12) Patent Application Publication
(10) Pub. No.: US 2008/0285120 A1
(43) Pub. Date: Nov. 20, 2008

(54) Digital Micro-Mirror Device

(76) Inventors: WEI-CHENG LO, Hsin-Chu City (TW); NIEN-HUI HSU, Hsin-Chu City (TW)

Correspondence Address: HDSL, 4331 STEVENS BATTLE LANE, FAIRFAX, VA, 22033, US

(21) Appl. No.: 11/959,221

(22) Filed: Dec. 18, 2007

(30) Foreign Application Priority Data
May 18, 2007 (TW) 096117835

(51) Int. Cl. G02B 5/20

(52) U.S. Cl. 359/361

(57) ABSTRACT

A digital micro-mirror device (DMD) has a housing, an active array being received in the housing, an optically transparent cover disposed above the active array for sealing the active array and introducing light beam to the active array, and a thermal conducting plate connected with the optically transparent cover and the housing.

### BACKGROUND

The present invention relates to a digital micro-mirror device, and particular to a digital micro-mirror device with a good heat dissipation characteristic.

Currently, one of the biggest problems associated with a typical digital micro-mirror device (DMD) is that of dissipating the heat caused largely by the very bright light focused on the surface of the small device as the DMD is applied to a projection system. The DMD also dissipates heat generated by internal operation of the device, although at a much lower level. For high performance and long life concerns, the DMD must be able to dissipate the large amount of heat, which is generated by the combination of incoming light flux on its surface and electrical operation internal of the device.

A conventional DMD 10 shown in FIGS. 1 and 2 includes an active array 16, an optical cover glass 15, a ceramic base 12, a metal frame 13, and a heat sink 11. The active array 16 is mounted onto the ceramic base 12, which is hermetically sealed in the DMD device 10 to prevent the active array 16 from becoming damaged. To accomplish this, a seal ring 14 is disposed on the ceramic base 12 so that the active array 16 is surrounded. The metal frame 13, which cooperates with the optical cover glass 15, is mounted onto the seal ring 14 to form a seal that encases the active array 16. Light beam from light source passes through the optical cover glass 15 to incident on the active array 16. The metal frame 13 is made from metal material. The heat sink 11 is mounted onto a bottom side of the base 12. The heat sink 11 absorbs the heat generated by the active array 16 when it is illuminated during its operation. In addition, a getter 17 is provided at the adjoining point of the optical cover glass 15 and the metal frame 13. Heat absorbed by the getter 17 is rapidly dissipated by the metal frame 13.

Another conventional DMD 20 is shown in FIGS. 3 and 4. The DMD 20 includes an active array 26, a glass frame 24, an optical cover glass 25, a ceramic base 22, a metal housing 23 and a heat sink 21. The active array 26 is mounted onto the ceramic base 22, which is hermetically sealed in the DMD device 20 to prevent the active array 26 from becoming damaged. To accomplish this, the glass frame 24, which cooperates with the optical cover glass 25, is mounted onto the ceramic base 22 to form a seal that encases the active array 26. The active array 26, the ceramic base 22, the glass frame 24, and the optical cover glass 25 are all received in a space defined by the metal housing 23. Light beam from light source passes through the optical cover glass 25 to incident on the active array 26. The heat sink 21 is mounted onto the bottom of the metal housing 23. The heat sink 21 absorbs the heat generated by the active array 26 when it is illuminated during its operation. In addition, a getter 27 is provided at the adjoining point of the optical cover glass 25 and the glass frame 24. However, the elements around the getter 27 are all made from glass material, which has a low heat conductive characteristic, and the heat sink 21 may keep a good heat dissipation characteristic of the metal housing 23. Thus, the temperatures of the locations adjacent the getter 27 and adjacent the bottom of the metal housing 23 are different. The temperature differential may be larger than 10° C., where the 10° C. temperature differential is the field standard.

Accordingly, what is needed is a DMD with a good heat dissipation characteristic.

### BRIEF SUMMARY

According an embodiment of the present invention, a digital micro-mirror device (DMD) has a housing; an active array being received in the housing; an optically transparent cover disposed above the active array for sealing the active array and introducing light beam to pass through thereof and incident on the active array; and a thermal conducting plate connected with the optically transparent cover and the housing.

According another embodiment of the present invention, a digital micro-mirror device (DMD) includes a metal housing; an active array being received in the metal housing; an optically transparent cover disposed above the active array for sealing the active array and introducing light beam to pass through thereof and incident on the active array; a glass frame disposed below the optically transparent cover and surrounding the active array for supporting the optically transparent cover, the glass frame cooperates with the optically transparent cover to form a seal and encases the active array; a seal ring provided between the glass fame and the sidewalls of the metal housing for defining the receiving space of the metal housing; a getter provided adjacent to the adjoining locations of the glass frame and the optically transparent cover; and a thermal conducting plate connected with the optically transparent cover and the housing.

The DMD utilizes one or more thermal conducting plates connecting a part of the optically transparent cover to the metal housing to transmit heat produced in the operation processes of the DMD from the optically transparent cover to the metal housing, and absorb the stray light projected at the DMD. The one or more thermal conducting plates transmit heat to the metal housing, which effectively reduces temperature difference between the bottom side of the metal housing and the position adjacent to the active array. The configuration of the one or more thermal conducting plates are designed according to the needs of the temperature difference being less than a predetermined temperature, such as 10° C. Thus, the usage life of the DMD may be assured.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, cross-sectional view of a conventional DMD;

FIG. 2 is a partially, schematic, cross-sectional view of a part of the DMD of FIG. 1;

FIG. 3 is a schematic, cross-sectional view of an another conventional DMD;

FIG. 4 is a partially, schematic, cross-sectional view of a part of the DMD of FIG. 3;

FIG. 5 is a schematic, cross-sectional view of a DMD according to a first embodiment of the present invention;

FIG. 6 is a schematic, isometric view of the DMD of FIG. 5;

FIG. 7 is a schematic, isometric view of a DMD according to a second embodiment of the present invention, which includes a plurality of protrusions formed at a thermal conducting plate;

FIG. 8 is a schematic, isometric view of a DMD according to a third embodiment of the present invention; and

FIG. 9 is a schematic, isometric view of a DMD according to a fourth embodiment of the present invention, which includes a plurality of strip-shaped thermal conducting plates.

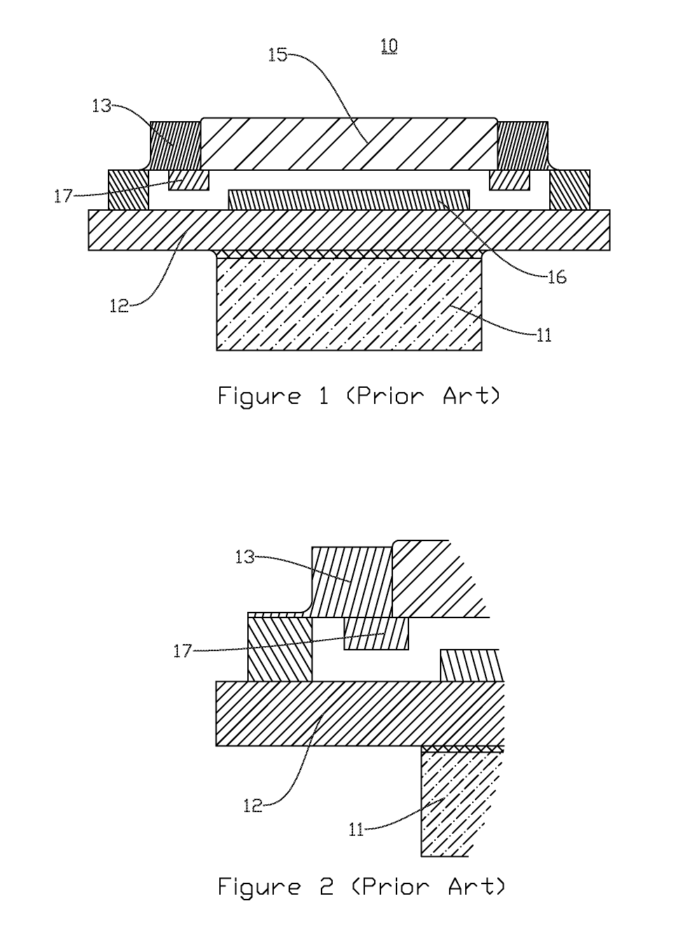

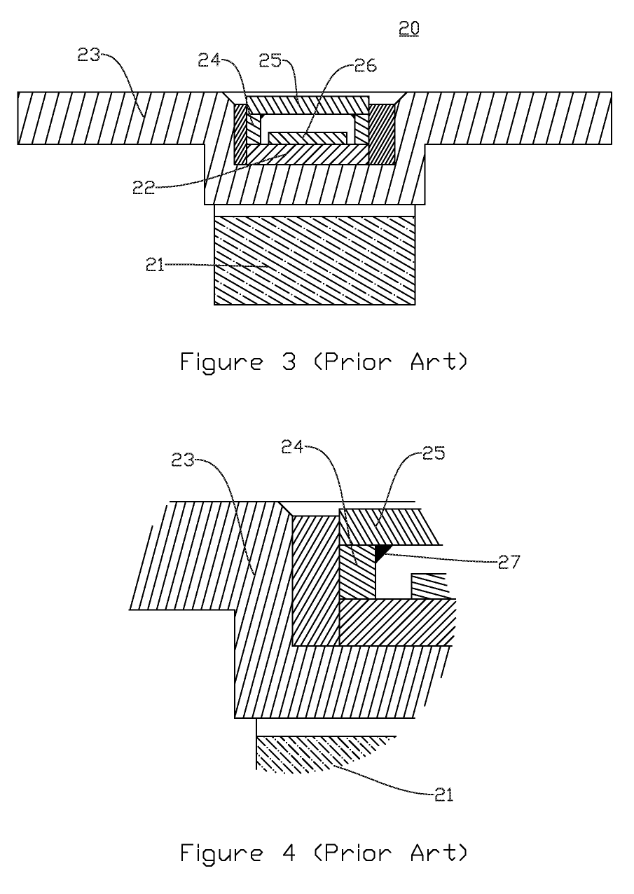

### DETAILED DESCRIPTION

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

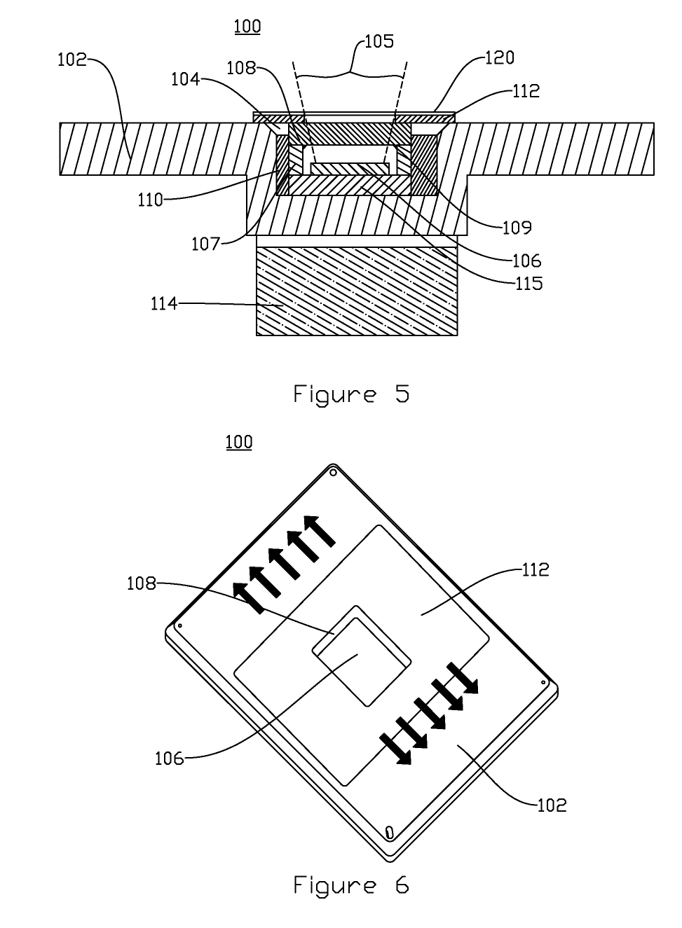

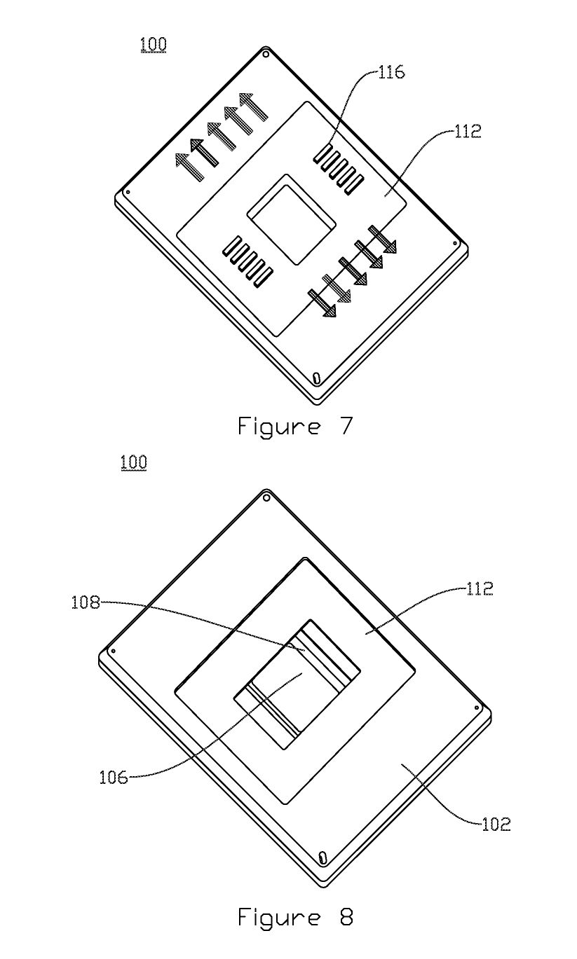

Referring to FIGS. 5 and 6, a digital micro-mirror device (DMD) 100 according to a first embodiment of the present invention is shown. The DMD 100 includes a housing 102 having a concave receiving space (not labeled) and defining an opening 104, an active array 106 received in the receiving space of the housing 102, an optically transparent cover 108 covering the active array 106, a ceramic base 115, a glass frame 107 and a seal ring 110. The seal ring 110 surrounds the optically transparent cover 108. The glass frame 107 is disposed below the optically transparent cover 108 and surrounding the active array 106 for supporting the optically transparent cover 108. The active array 106 is mounted onto the ceramic base 115, which is hermetically sealed in the DMD device 100 to prevent the array 106 from becoming damaged. To accomplish this, the glass frame 107, which cooperates with the optically transparent cover 108, is mounted onto the ceramic base 115 to form a seal that encases the active array 106. In addition, the seal ring 110 is provided between the glass fame 107 and the sidewalls of the housing 102 for defining the receiving space of the housing 102. The active array 106, the ceramic base 115, the glass frame 107, and the optically transparent cover 108 are all received in the receiving space of the housing 102. The optically transparent cover 108 has a display region 105. A light beam from light source passes through the display region 105 of the optically transparent cover 108 to incident on the active array 106 and further to be reflected to the outside of the DMD 100 by the active array 106. A heat sink 114 is mounted onto a bottom side of the metal housing 102, and corresponding to the active array 106. The heat sink 114 absorbs the heat generated by the active array 106 when it is illuminated by the light beam during its operation. A getter 109 is provided adjacent to the adjoining locations of the glass frame 107 and the optically transparent cover 108. The housing 102 is made from a material having a good thermal conductive characteristic, such as metal material. The optically transparent cover 108 is typically a piece of glass or other optical transmissive material that is mounted and sealed on the glass frame 107.

The DMD 100 further includes a thermal conducting plate 112, which corresponds to the seal ring 110 and is disposed on the seal ring 110, surrounding the display region 105 of the optically transparent cover 108. In a preferred embodiment, the thermal conducting plate 112 is a straight-flanked ring, i.e. a window frame configuration, which is connected to the metal housing 102. The thermal conducting plate 112 is made from black thermal conductive material or other thermal conductive materials having high thermal conductive characteristics, such as metal, graphite or materials comprising silicon.

In operation, when is the light beam is projected on the DMD 100, a large part of the light beam is projected on the active array 106 where it is modulated and reflected along a predetermined direction, and a small part of the light beam is projected on the thermal conducting plate 112 where it is absorbed. Heat at the thermal conducting plate 112, produced by the light beam, is dissipated by the metal housing 102 connected with the thermal conducting plate 112. In addition, the thermal conducting plate 112 is disposed adjacent to the upper of the getter 109, and connected with the metal housing 102 and the optically transparent cover 108, therefore it rapidly conducts heat produced by the getter 109 to the metal housing 102. The heat thereof may be rapidly dissipated by the metal housing 102 and the heat sink 114 mounted onto the bottom side of the metal housing 102.

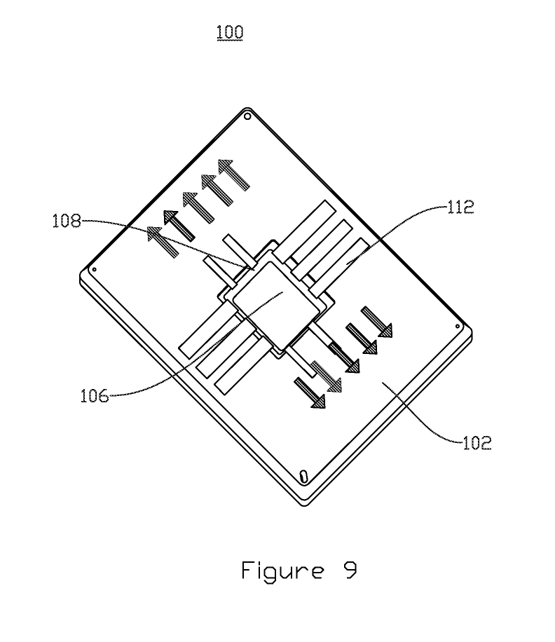

In alternative embodiments, the thermal conducting plate 112 may have a fin-like outer surface or have a plurality of protrusions 116 (as shown in FIG. 7) on the outer surface, which may further add the area of the outer surface and efficiently improve the heat dissipation efficiency. In addition, the thermal conducting plate 112 may further have an optical absorption layer 120 covering the thermal conducting plate 112, which is used to absorb stray light beams around the DMD 100. Moreover, the thermal conducting plate 112 may not only directly connect the metal housing 102 and the optically transparent cover 108, but also may extend to the peripheral sides of the metal housing 102 for adding the heat conducting ways. In a preferred embodiment, the thermal conducting plate 112 may just be disposed at outsides of the display region 105. An opening of the thermal conducting plate 112 does not need to cling to the display region 105, and it may be designed to cover the metal housing 102 and partly connect the metal housing 102 and the optically transparent cover 108 as shown in FIG. 8, according to the design needs. In modifications, the thermal conducting plate 112 also may cover part of the display region 105. The thermal conducting plate 112 also is not limited to be of window fame-shaped, and it may be one or more strips (as shown in FIG. 9). The plurality of strips-shaped thermal conducting plates 112 may be disposed at any one side, two sides, three sides or peripheral sides of the optically transparent cover 108, as long as the thermal conducting plates 112 connects a part of the optically transparent cover 108 to the metal housing 102, which effectively transmits heat of the optically transparent cover 108 to the metal housing 102. The thermal conducting plates 112 may also directly connect to a housing of an external optical device, such as a projecting displaying system (not shown).

To sum up, the DMD 100 of an embodiment utilizes one or more thermal conducting plates 112 connecting a part of the optically transparent cover 108 to the metal housing 102 to transmit heat produced in the operation processes of the DMD 100 from the optically transparent cover 108 to the metal housing 102 and the heat sink 114, and absorb the stray light projected around the display region 105 of the DMD 100. The one or more thermal conducting plates 112 transmit heat to the metal housing 102, which effectively reduces temperature difference between the bottom side of the metal housing 102 and the position adjacent to the active array 106. The configuration of the one or more thermal conducting plates 112 may be designed or adjusted according to the needs such as controlling the temperature difference being less than a predetermined temperature, such as 10° C. Thus, the usage life of the DMD 100 may be assured. When the thermal conducting plates 112 are directly connect to a housing of an external optical device, it may further conduct heat to the optical device for utilizing the optical device to rapidly dissipate heat and reduce the temperature of the active array 106.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A digital micro-mirror device comprising:
a housing;
an active array being received in the housing;
an optically transparent cover disposed above the active array for sealing the active array and introducing light beam to pass through thereof and incident on the active array; and
a thermal conducting plate connected with the optically transparent cover and the housing.

2. The digital micro-mirror device as claimed in claim 1, wherein the optically transparent cover comprises a display region, at which the light beam passes through thereof to incident on the active array and further to be reflected to the outside of the digital micro-mirror device by the active array.

3. The digital micro-mirror device as claimed in claim 2, wherein the thermal conducting plate is of a window frame configuration, surrounding the display region.

4. The digital micro-mirror device as claimed in claim 1, wherein the thermal conducting plate includes one or more strip-shaped structures, and a part of them interconnect the optically transparent cover and the housing.

5. The digital micro-mirror device as claimed in claim 1, wherein the thermal conducting plate is made from a black thermal conductive material.

6. The digital micro-mirror device as claimed in claim 1, wherein the thermal conducting plate is made from metal, graphite or materials comprising silicon.

7. The digital micro-mirror device as claimed in claim 1, further comprising an optical absorption layer on the thermal conducting plate.

8. The digital micro-mirror device as claimed in claim 1, wherein the thermal conducting plate has a fin-like outer surface or a plurality of protrusions on an outer surface thereof.

9. The digital micro-mirror device as claimed in claim 1, wherein the housing is made from metal.

10. The digital micro-mirror device as claimed in claim 1, wherein the optically transparent cover is made from glass.

11. The digital micro-mirror device as claimed in claim 2, wherein the thermal conducting plate exposes at least part of the display region.

12. A digital micro-mirror device comprising:
a metal housing having a receiving space;
an active array being received in the metal housing;
an optically transparent cover disposed above the active array for sealing the active array and introducing light beam to pass through thereof and incident on the active array;
a glass frame disposed below the optically transparent cover and surrounding the active array for supporting the optically transparent cover, the glass frame cooperating with the optically transparent cover to form a seal and encase the active array;
a seal ring provided between the glass fame and the sidewalls of the metal housing for defining the receiving space of the metal housing;
a getter provided adjacent to the adjoining locations of the glass frame and the optically transparent cover; and
a thermal conducting plate connected with the optically transparent cover and the housing.

13. The digital micro-mirror device as claimed in claim 12, wherein the optically transparent cover is made from glass.

14. The digital micro-mirror device as claimed in claim 12, wherein the thermal conducting plate is made from metal, graphite or materials comprising silicon.

15. The digital micro-mirror device as claimed in claim 12, further comprising an optical absorption layer on the thermal conducting plate.

16. The digital micro-mirror device as claimed in claim 12, further comprising a heat sink mounted onto a bottom side of the metal housing, and corresponding to the active array.

17. The digital micro-mirror device as claimed in claim 12, wherein the optically transparent cover comprises a display region, at which the light beam pass through thereof to incident on the active array and further to be reflected to the outside of the digital micro-mirror device by the active array.
